(19) United States
(12) Patent Application Publication
(10) Pub. No.: US 2021/0351609 A1
(43) Pub. Date: Nov. 11, 2021

(54) POWER CONTROL SYSTEM WITH AUTOMATIC BALANCING BETWEEN DUAL INPUTS OF POWER

(71) Applicant: HONGFUJIN PRECISION ELECTRONICS(TIANJIN)CO.,LTD., Tianjin (CN)

(72) Inventors: KAI-FU CHEN, New Taipei (TW); CHIA-YUN LEE, New Taipei (TW); KUO-RONG CHEN, New Taipei (TW); KUEI-CHIH HOU, New Taipei (TW)

(21) Appl. No.: 16/878,232

(22) Filed: May 19, 2020

(30) Foreign Application Priority Data
May 6, 2020 (CN) 202010374355.2

(51) Int. Cl. H02J 9/06

(52) U.S. Cl. CPC H02J 9/068

(57) ABSTRACT

A power control system with automatic balancing between dual inputs of power includes a first power supply, a second power supply, a power supply, a second power supply, a plurality of first power supply units and a plurality of second power supply units. The first power supply unit includes a first switch unit, and the second power supply unit includes a second switch unit. When the first power supply is powered off, the second power supply is switched through the first switch unit to power the first power supply unit. When the second power supply is powered off, the first power supply is switched through the second switch unit to power the second power supply unit. The power control system disclosed improves power usage and efficiency of the power supplies.

### FIELD

The subject matter herein generally relates to power supplies.

### BACKGROUND

In general, a power supply unit (power supply unit, PSU) has an automatic transfer switching (ATS) function, and supports dual inputs of power, one to be a standby in case of power-off. The utilization rate of one input is low, and the use of the other is very much higher. The stability of a power supply system, and therefore maintenance, can suffer when there is an instantaneous high power switch to the standby circuit, there are also risks to the ultimate power source.

Therefore, improvement is desired.

### BRIEF DESCRIPTION OF THE DRAWINGS

Implementations of the present disclosure will now be described, by way of embodiments, with reference to the attached figures.

FIG. 1 is a block diagram of an embodiment of a power control system of the present disclosure.

FIG. 2 is a schematic diagram of an embodiment of the power control system of FIG. 1.

FIG. 3 is a schematic diagram of another embodiment of the power control system of FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

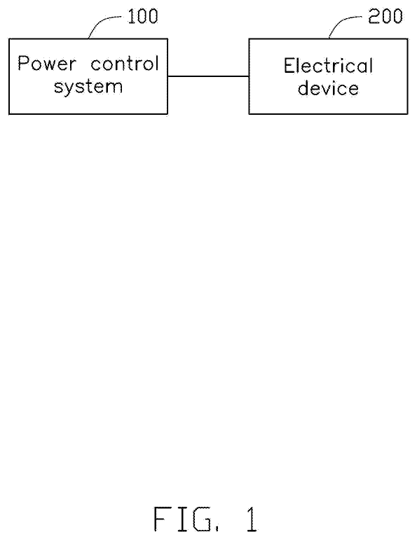

FIG. 1 illustrates a power control system 100 in accordance with an embodiment of the present disclosure. The power control system 100 supplies power for an electrical device 200. In the embodiment, the electrical device 200 can be a server. In other embodiments, the electrical device 200 also can be any other load.

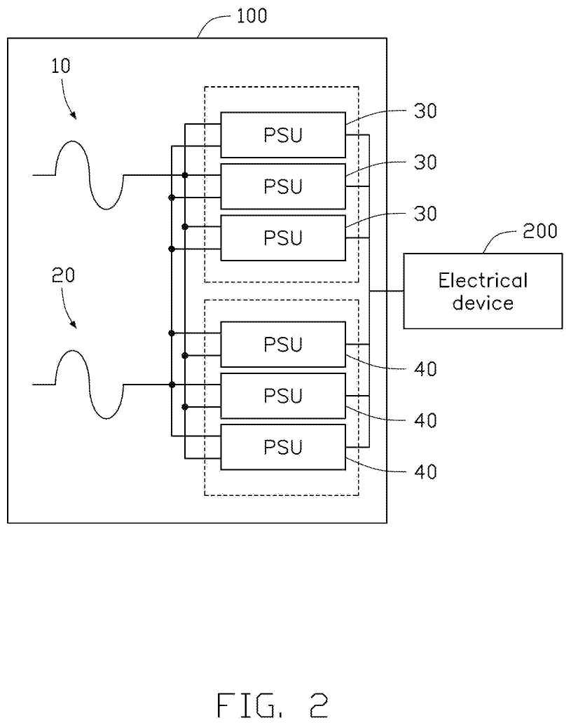

FIG. 2 illustrates the power control system 100 which includes a first power supply 10, a second power supply 20, and a plurality of power supply units (PSUs) 30, and a plurality of PSUs 40.

In the embodiment, there are three PSUs 30 and three PSUs 40. In other embodiments, the number of each is equal and can be adjusted according to actual needs.

The PSUs 30 are electrically coupled to the first power supply 10 and the second power supply 20, and the PSUs 40 are also electrically coupled to the first power supply 10 and the second power supply 20. The PSUs 30 may serve as a first power supply block, and the PSUs 40 may serve as a second power supply block. Either or both of the first power supply block and the second power supply block can provide electrical energy to the electrical device 200.

In an embodiment, both the first power supply 10 and the second power supply 20 may be alternating current (AC) power supply or direct current (DC) power supply.

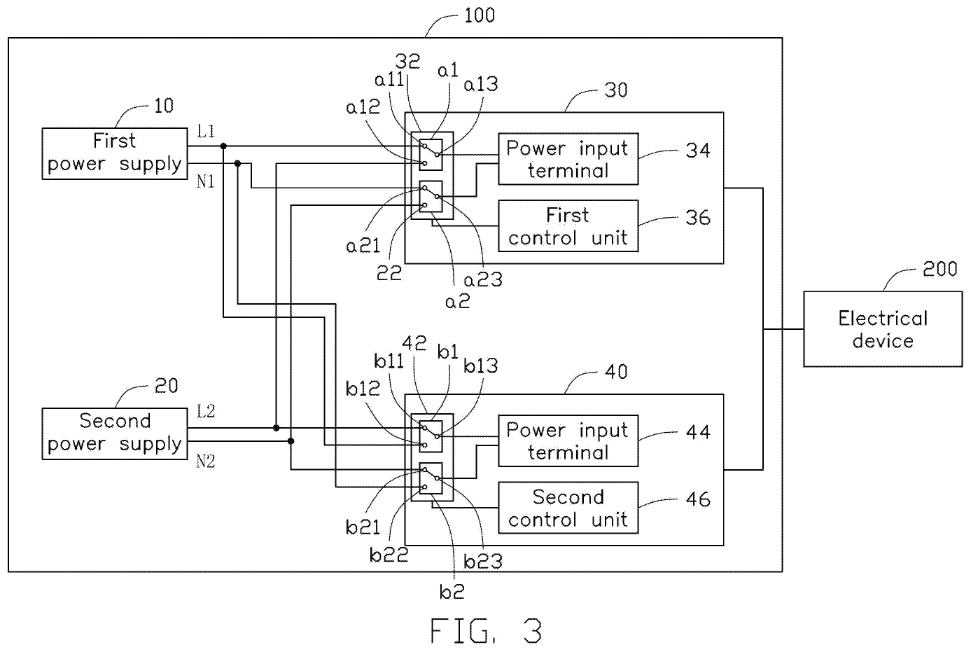

In an embodiment, the PSU 30 includes a first switch unit 32 (shown in FIG. 3), and the PSU 40 includes a second switch unit 42 (shown in FIG. 3). The first power supply 10 and the second power supply 20 are electrically coupled to the first power supply unit 30 through the first switch unit 32, and the first power supply 10 and the second power supply 20 are electrically coupled to the second power supply unit 40 through the second switch unit 42.

When both the first power supply 10 and the second power supply 20 are normally powered, the first switch unit 32 may be used to supply power to each PSU 30, and the second switch unit 42 can supply power to each PSU 40. In everyday working, the first power supply 10 is used to supply power to three PSUs 30, and the second power supply 20 is used to supply power to three PSUs 40. In normal working, a power supply rate of the first power supply 10 to the power supply system is 50%, and the power supply rate of the second power supply 20 to the power supply system is also 50%, balancing the power supply.

When the first power supply 10 operates abnormally and is powered off, the first switch unit 32 will switch the second power supply 20 to power each PSU 30. At this time, the second power supply 20 will be supplying power to six PSUs, the power supply rate of the second power supply 20 will be 100%.

When the second power supply 20 operates abnormally and is powered off, the second switch unit 42 will switch the first power supply 10 to power each PSU 40. At this time, the first power supply 10 will be supplying power to six PSUs, the power supply rate of the first power supply 10 will be 100%.

In the embodiment, the first switch unit 32 and the second switch unit 42 can be automatic transfer switches (ATS).

FIG. 3 illustrates that the PSU 30 includes a power input terminal 34. The first switch unit 32 is electrically coupled between the power input terminal 34 and the first power supply 10, and the first switch unit 32 is electrically coupled between the power input terminal 34 and the second power supply 20. The PSU 40 includes a power input terminal 44. The second switch unit 42 is electrically coupled between the power input terminal 44 and the first power supply 10, and the second switch unit 42 is electrically coupled between the power input terminal 44 and the second power supply 20.

In the embodiment, the first switch unit 32 includes a first switch element a1 and a second switch element a2.

A first output terminal L1 of the first power supply 10 is electrically coupled to a first terminal a-eleven (all) of the first switch element a1, a first output terminal L2 of the second power supply 20 is electrically coupled to a second terminal a-twelve (a12) of the first switch element a1. A third terminal a-thirteen (a13) of the first switch element a1 is electrically coupled to the power input terminal 34 of the PSU 30.

A second output terminal N1 of the first power supply 10 is electrically coupled to a first terminal a21 of the second switch element a2, a second output terminal N2 of the second power supply 20 is electrically coupled to a second terminal a-twenty-two (a22) of the second switch element a2, and a third terminal a-twenty-three (a23) of the second switch element a2 is electrically coupled to the power input terminal 34 of the PSU 30.

In the embodiment, the second switch unit 42 includes a third switch element b1 and a fourth switch element b2.

A first output terminal L2 of the second power supply 20 is electrically coupled to a first terminal b11 of the third switch element b1, a first output terminal L1 of the first power supply 10 is electrically coupled to a second terminal b12 of the third switch element b1, and a third terminal b13 of the third switch element b1 is electrically coupled to the power input terminal 44 of the PSU 40.

A second output terminal N2 of the second power supply 20 is electrically coupled to a first terminal b21 of the fourth switch element b2, a second output terminal N1 of the first power supply 10 is electrically coupled to a second terminal b22 of the fourth switch element b2, and a third terminal b23of the fourth switch element b2 is electrically coupled to the power input terminal 44 of the PSU 40.

In an embodiment, each of the first switch element a1, the second switch element a2, the third switch element b1, and the fourth switch element b2 can be a relay.

In the embodiment, the PSU 30 further includes a first control unit 36, and the PSU 40 includes a second control unit 46.

In an embodiment, the first control unit 36 and the second control unit 46 can each be a micro control unit (MCU).

The first control unit 36 is electrically coupled to the first switch unit 32 for controlling the first switch unit 32 to switch the second power supply 20 to supply PSU 30 when the first power supply 10 is powered off. The second control unit 46 is electrically coupled to the second switch unit 42 for controlling the second switch unit 42 to switch the first power supply 10 to supply PSU 40 when the second power supply 20 is powered off.

The figures only show a circuit connection diagram of one PSU 30 and one PSU 40, the circuit structure and connection relationship of the remaining PSUs 30 are the same as those of PSU 30 shown in the figure. The circuit structure and connection relationship of the remaining PSUs 40 are the same as those of the PSU 40 shown in the figure, so they will not be repeated here.

In use, when both the first power supply 10 and the second power supply 20 are working normally, the third terminal a13 of the first switch element a1 is electrically connected to the first terminal a11 of the first switch element a1. The third terminal a23 of the second switch element a2 is electrically connected to the first terminal a21 of the second switch element a2. The third terminal b13 of the third switch element b1 is electrically connected to the first terminal b 11 of the third switch element b1, and the third terminal b23 of the fourth switch element b2 is electrically connected to the first terminal b21 of the fourth switch element b2. Therefore, the first power supply 10 will provide power to three PSUs 30, and the second power supply 20 will provide power to the three PSUs 40. The power supply rate of the first power supply 10 is 50%, and the power supply rate of the second power supply 20 is also 50%. This avoids the server cabinet or other cabinet operating on an exclusive basis when powered by dual power supplies and can improve the power utilization and efficiency of dual power supplies.

When the first power supply 10 is powered off, the first control unit 36 controls the third terminal a13 of the first switch element a1 to switch to the second terminal a12 of the first switch element a1. The first control unit 36 controls the third terminal a23 of the second switch element a2 to switch to the second terminal a22 of the second switch element a2. At this time, the second power supply 20 will supply power to the PSU 30. That is, the PSU 30 and the PSU 40 will both be provided with power by the second power supply 20.

When the second power supply 20 is powered off, the second control unit 46 will control the third terminal b13 of the third switch element b1 to switch to the second terminal a22 of the third switch element a2, the second control unit 46 also switches the third terminal b23 of the fourth switch element b2 to the second terminal b22 of the fourth switch element b2. At this time, the first power supply 10 will supply power to the PSU 40. That is, the PSU 30 and the PSU 40 will both be powered by the first power supply 10.

Therefore, the power supply control system 100 switches the second power supply 20 through the first switch unit 32 to supply power to the PSU 30 when the first power supply 10 is powered off, and the second switch unit 42 switches the first power supply 10 to supply power to the PSU 40 when the power is turned off. The power supply control system provided by the disclosure allows the cabinet to achieve dual-input average use when powered by dual power supplies, improves the power utilization and efficiency in dual power supply applications, and also improves the stability of power input.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the exemplary embodiments described above may be modified within the scope of the claims.

1. A power control system configured for supplying an electrical device and comprising:
a first power supply;
a second power supply;
a plurality of first power supply units; wherein each of the first power supply units comprises a first switch unit;
a plurality of second power supply units; wherein each of the second power supply units comprises a second switch unit;
wherein the first power supply and the second power supply are electrically coupled to the first power supply unit through the first switch unit; and the first power supply and the second power supply are electrically coupled to the second power supply unit through the second switch unit;
wherein when the first power supply and the second power supply are normally powered, the first switch units supply the first power supply to the first power supply units, and the second switch units supply the second power supply to the second power supply units, a power supply rate of the first power supply is approximately 50%, a power supply rate of the second power supply is approximately 50%, and the first power supply and the second power supply are in power supply balance;
wherein when the first power supply is abnormally powered, the first switch units switch the second power supply to supply power to the first power supply units; and
wherein when the second power supply is abnormally powered, the second switch units switch the first power supply to supply power to the second power supply units.

2. The power control system according to claim 1, wherein the first power supply unit comprises a power input terminal, and the first switch unit is electrically coupled between the power input terminal of the first power supply unit and the first power supply.

3. The power control system according to claim 1, wherein the second power supply unit comprises a power input terminal, and the second switch unit is electrically coupled between the power input terminal of the second power supply unit and the second power supply.

4. The power control system according to claim 2, wherein the first switch unit comprises a first switch element, a first output terminal of the first power supply is electrically coupled to a first terminal of the first switch element, a first output terminal of the second power supply is electrically coupled to a second terminal of the first switch element, and a third terminal of the first switch element is electrically coupled to the power input terminal of the first power supply unit; wherein when the first power supply is normally powered, the third terminal of the first switch element is electrically connected to the first terminal of the first switch element; wherein when the first power supply is abnormally powered, the third terminal of the first switch element switches to the second terminal of the first switch element.

5. The power control system according to claim 4, wherein the first switch unit further comprises a second switch element, a second output terminal of the first power supply is electrically coupled to a first terminal of the second switch element, a second output terminal of the second power supply is electrically coupled to a second terminal of the second switch element, and a third terminal of the second switch element is electrically coupled to the power input terminal of the first power supply unit; wherein when the first power supply is normally powered, the third terminal of the second switch element is electrically connected to the first terminal of the second switching element; wherein when the first power supply is abnormally powered, the third terminal of the second switch element switches to the second terminal of the second switch element.

6. The power control system according to claim 3, wherein the second switch unit comprises a third switch element, a first output terminal of the second power supply is electrically coupled to a first terminal of the third switch element, a first output terminal of the first power supply is electrically coupled to a second terminal of the third switch element, and a third terminal of the third switch element is electrically coupled to the power input terminal of the second power supply unit; wherein when the second power supply is normally powered, the third terminal of the third switch element is electrically connected to the first terminal of the third switch element; wherein when the second power supply is abnormally powered, the third terminal of the third switch element switches to the second terminal of the third switch element.

7. The power control system according to claim 6, wherein the second switch unit further comprises a fourth switch element, a second output terminal of the second power supply is electrically coupled to a first terminal of the fourth switch element, a second output terminal of the first power supply is electrically coupled to a second terminal of the fourth switch element, and a third terminal of the fourth switch element is electrically coupled to the power input terminal of the second power supply unit; wherein when the second power supply is normally powered, the third terminal of the fourth switch element is electrically connected to the first terminal of the fourth switch element; wherein when the second power supply is abnormally powered, the third terminal of the fourth switch element is electrically connected to the second terminal of the fourth switch element.

8. The power control system according to claim 1, wherein the first power supply unit further comprises a first control unit, the first control unit is electrically coupled to the first switch unit, and the first control unit controls the first switch unit to switch the second power supply to supply for the first power supply unit when the first power supply is abnormally powered.

9. The power control system according to claim 1, wherein the second power supply unit further comprises a second control unit, the second control unit is electrically coupled to the second switch unit, and the second control unit controls the second switch units to switch the first power supply to supply power for the second power supply unit when the second power supply is abnormally powered.

10. The power control system according to claim 1, wherein the first switch unit and the second switch unit are automatic transfer switching (ATS) devices.

11. A power control system configured for supplying an electrical device and comprising:
a first power supply;
a second power supply;
a plurality of first power supply units; wherein each of the first power supply units comprises a first switch unit;
a plurality of second power supply units; wherein each of the second power supply units comprises a second switch unit;
wherein the first power supply and the second power supply are electrically coupled to the first power supply unit through the first switch unit; and the first power supply and the second power supply are electrically coupled to the second power supply unit through the second switch unit;
wherein when the first power supply and the second power supply are normally powered, the first switch units supply the first power supply to the first power supply units, and the second switch units supply the second power supply to the second power supply units, a power supply rate of the first power supply is approximately 50%, a power supply rate of the second power supply is approximately 50%, and the first power supply and the second power supply are in power supply balance;
wherein when the first power supply is abnormally powered, the first switch units switch the second power supply to supply power to the first power supply units;
wherein when the second power supply is abnormally powered, the second switch units switch the first power supply to supply power to the second power supply units;
wherein the first power supply unit further comprises a first control unit, the first control unit is electrically coupled to the first switch unit, and the first control unit controls the first switch unit to switch the second power supply to supply power for the first power supply unit when the first power supply is abnormally powered;
wherein the second power supply unit further comprises a second control unit, the second control unit is electrically coupled to the second switch unit, and the second control unit controls the second switch units to switch the first power supply to supply power for the second power supply unit when the second power supply is abnormally powered; and
wherein when the first power supply and the second power supply are normally powered, a power supply rate of the first power supply is approximately 50%, the power supply rate of the second power supply is approximately 50%, and the first power supply and the second power supply are in power supply balance.

12. The power control system according to claim 11, wherein the first power supply unit comprises a power input terminal, and the first switch unit is electrically coupled between the power input terminal of the first power supply unit and the first power supply.

13. The power control system according to claim 11, wherein the second power supply unit comprises a power input terminal, and the second switch unit is electrically coupled between the power input terminal of the second power supply unit and the second power supply.

14. The power control system according to claim 12, wherein the first switch unit comprises a first switch element, a first output terminal of the first power supply is electrically coupled to a first terminal of the first switch element, a first output terminal of the second power supply is electrically coupled to a second terminal of the first switch element, and a third terminal of the first switch element is electrically coupled to the power input terminal of the first power supply unit; wherein when the first power supply is normally powered, the third terminal of the first switch element is electrically connected to the first terminal of the first switch element; wherein when the first power supply is abnormally powered, the third terminal of the first switch element switches to the second terminal of the first switch element.

15. The power control system according to claim 14, wherein the first switch unit further comprises a second switch element, a second output terminal of the first power supply is electrically coupled to a first terminal of the second switch element, a second output terminal of the second power supply is electrically coupled to a second terminal of the second switch element, and a third terminal of the second switch element is electrically coupled to the power input terminal of the first power supply unit; wherein when the first power supply is normally powered, the third terminal of the second switch element is electrically connected to the first terminal of the second switching element; wherein when the first power supply is abnormally powered, the third terminal of the second switch element switches to the second terminal of the second switch element.

16. The power control system according to claim 13, wherein the second switch unit comprises a third switch element, a first output terminal of the second power supply is electrically coupled to a first terminal of the third switch element, a first output terminal of the first power supply is electrically coupled to a second terminal of the third switch element, and a third terminal of the third switch element is electrically coupled to the power input terminal of the second power supply unit; wherein when the second power supply is normally powered, the third terminal of the third switch element is electrically connected to the first terminal of the third switch element; wherein when the second power supply is abnormally powered, the third terminal of the third switch element switches to the second terminal of the third switch element.

17. The power control system according to claim 16, wherein the second switch unit further comprises a fourth switch element, a second output terminal of the second power supply is electrically coupled to a first terminal of the fourth switch element, a second output terminal of the first power supply is electrically coupled to a second terminal of the fourth switch element, and a third terminal of the fourth switch element is electrically coupled to the power input terminal of the second power supply unit; wherein when the second power supply is normally powered, the third terminal of the fourth switch element is electrically connected to the first terminal of the fourth switch element; wherein when the second power supply is abnormally powered, the third terminal of the fourth switch element is electrically connected to the second terminal of the fourth switch element.

18. The power control system according to claim 11, wherein the first switch unit and the second switch unit are automatic transfer switching (ATS) devices.
